(19) United States
(12) Patent Application Publication
(10) Pub. No.: US 2018/0217529 A1
(43) Pub. Date: Aug. 2, 2018

(54) BELT CONVEYANCE APPARATUS

(71) Applicant: CANON KABUSHIKI KAISHA, Tokyo (JP)

(72) Inventors: Masataka Fumoto, Tokyo (JP); Dai Kanai, Abiko-shi (JP); Ran Kudo, Tokyo (JP)

(21) Appl. No.: 15/880,405

(22) Filed: Jan. 25, 2018

(30) Foreign Application Priority Data
Jan. 30, 2017 (JP) 2017-014908

(51) Int. Cl. G03G 15/16; G03G 15/00; B65G 39/16

(52) U.S. Cl. CPC G03G 15/1615; G03G 15/755; G03G 2215/00156; B65G 39/16; G03G 15/161

(57) ABSTRACT

A stretching roller for stretching an intermediate transfer belt is tiltably disposed, and includes a sliding ring unrotatably disposed at both axial ends of a roller portion. The intermediate transfer belt winds and slidably rotates around the sliding ring. The sliding ring has a tapered portion inclined so that the outer diameter increases toward the axial end side of the stretching roller. The tapered portion is formed so that the inclination angle with respect to the central axis of the stretching roller differs at least in part in the circumferential direction.

### BACKGROUND OF THE INVENTION

### Field of the Invention

The present disclosure generally relates to a belt conveyance apparatus having a rotary belt member stretched by a plurality of tension rollers.

### Description of the Related Art

For example, an image forming apparatus is known to be configured to transfer toner images from a plurality of photosensitive drums to an intermediate transfer belt as an endless belt member in an overlapped way, and collectively transfer the images from the intermediate transfer belt to a recording material. Such an intermediate transfer belt is stretched and rotatably driven by a plurality of tension rollers. In this rotating state, the intermediate transfer belt laterally moves to either side because of the outer diameter accuracy of the rollers and the alignment accuracy between the rollers.

Japanese Unexamined Patent Application Publication No. 2001-520611 discusses a configuration in which a sliding portion having a tapered outer circumferential surface is provided at both axial ends of a roller portion of a steering roller tilted by the balance of the frictional force between the sliding portion and a belt member, and a lateral movement of the belt member is automatically controlled.

However, if the entire circumference of the sliding portion is formed in a tapered shape, a low material proof strength (yield stress) of the belt member causes a distortion at an edge portion of the belt member winding around the sliding portion when the belt member runs on the sliding portion. This distortion possibly shortens the life of the belt member. If the belt member is thin, the belt member is likely to wave to easily produce a shearing stress at the edge portion of the belt member, possibly causing a crack.

A possible measure is to reduce the taper angle (difference in outer diameter between the roller portion and the sliding portion). However, in this case, the frictional force between the belt member and the sliding portion decreases in order to decrease the moment occurring so as to tilt the steering roller. As a result, it becomes hard to ensure the rudder angle of the steering roller for controlling the lateral movement of the belt member, possibly making it hard to ensure sufficient steering performance.

### SUMMARY OF THE INVENTION

The present disclosure is directed to a belt conveyance apparatus capable of ensuring steering performance while reducing a stress at edge portions of a belt member.

According to an aspect of the present disclosure, a belt conveyance apparatus includes an endless belt member configured to rotate, and a stretching roller configured to stretch the belt member and tilt to make the belt member movable in a lateral direction intersecting with a rotational direction of the belt member, the stretching roller including a roller portion configured to rotate together with the belt member, and a sliding portion, that does not rotate with the belt member, wherein a distance between an outer surface of the sliding portion at a first position and an outer surface of the roller portion with respect to a radial direction of the roller portion in a first predetermined cross section including a rotating axis line of the roller portion is larger than a distance between an outer surface of the sliding portion at a second position and an outer surface of the roller portion with respect to the radial direction in the first predetermined cross section, the second position is inside the first position with respect to the rotating axis line of the roller portion, wherein when a distance between an outer surface of the sliding portion and an outer surface of the roller portion with respect to a radial direction of the roller portion in a second predetermined cross section perpendicularly intersecting with the rotating axis line of the roller portion is denoted by Δr, and a maximum value of the Δr in a winding area where the belt member winds is denoted by Δrmax, the Δr at a middle position of the winding area with respect to a rotational direction of the roller portion is 50% or more of the Δrmax, and an area, where the Δr is 50% or more of the Δrmax occupies 40% or more and 80% or less of the entire winding area, and wherein the second predetermined cross section passes through a lateral end of the belt member when a lateral center position of the belt member is positioned at a lateral center of the roller portion.

Further features of the present disclosure will become apparent from the following description of exemplary embodiments with reference to the attached drawings.

### BRIEF DESCRIPTION OF THE DRAWINGS

FIG. 1 illustrates an overall configuration of an image forming apparatus according to a first exemplary embodiment.

FIG. 2 is a perspective view illustrating a steering roller according to the first exemplary embodiment.

FIG. 3A is a perspective view illustrating a belt portion stretched by a steering roller according to a comparative example, and FIG. 3B is a side view illustrating the belt portion.

FIG. 4 is a schematic view illustrating a principle of automatic lateral movement control based on the steering roller.

FIG. 5A is a schematic view illustrating a case where the belt position with respect to the steering roller according to the comparative example is in the neutral state, and FIG. 5B is a schematic view illustrating a case where the belt position laterally moves to one side.

FIG. 6 illustrates a fatigue limit curve (S-N curve) of a polyimide thin film and a polyetheretherketone thin film.

FIG. 7A is a perspective view illustrating a belt portion stretched by a steering roller according to a first exemplary embodiment, and FIG. 7B is a side view illustrating the belt portion.

FIG. 8 illustrates a taper profile with respect to the phase of a sliding ring in the belt winding direction according to the first exemplary embodiment.

FIG. 9A illustrates a relation between the taper angle and the tilting rudder angle of the steering roller according to an example calculated through a simulation, and FIG. 9B illustrates the relation according to the comparative example.

FIG. 10A illustrates a result of calculating a principal stress at end portions of the belt in a simulation, and FIG. 10B illustrates a result of calculating the maximum value of a principal stress at an edge portion of the belt in a simulation according to an example and the comparative example.

FIG. 11 illustrates a taper profile with respect to the phase of a sliding ring in the belt winding direction according to a second exemplary embodiment.

FIG. 12 illustrates a result of calculating a relation between the set position with the maximum taper angle and the tilting rudder angle of the steering roller in a simulation according to a third exemplary embodiment.

### DESCRIPTION OF THE EMBODIMENTS

Various exemplary embodiments, features, and aspects of the disclosure will be described in detail below with reference to the drawings.

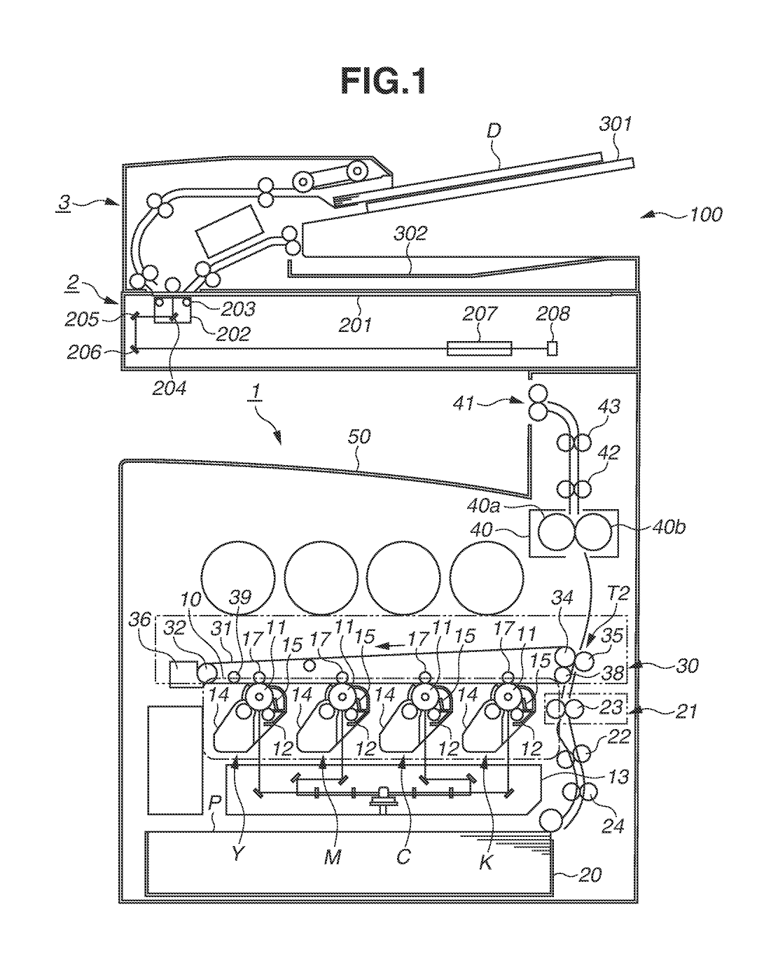

A first exemplary embodiment will be described below with reference to FIGS. 1 to 10A and 10B. An overall configuration of an image forming apparatus according to the present exemplary embodiment will be described below with reference to FIG. 1.

### [Image Forming Apparatus]

An image forming apparatus 100 includes an image forming unit 1, an image reading unit 2 disposed above the image forming unit 1, and a document conveyance unit 3 placed on the image reading unit 2. The document conveyance unit 3 sequentially feeds document sheets D upwardly set on a document tray 301 to the image reading unit 2, one by one from the first page. After a document sheet D passes through a platen glass 201 of the image reading unit 2 via a curved path, the document conveyance unit 3 discharges the document sheet D onto a discharge tray 302.

When the document sheet D conveyed by the document conveyance unit 3 passes through the platen glass 201 from left to right, the image reading unit 2 performs image reading processing via the scanner unit 202 held at a predetermined position. More specifically, the image reading unit 2 irradiates the reading surface of the document sheet D with light of a lamp 203 of the scanner unit 202 and guides reflected light from the document sheet D to a lens 207 through mirrors 204, 205, and 206. The light passing through the lens 207 is focused on the imaging plane of an image sensor 208. The image sensor 208 converts this light into an electrical digital signal and transmits the signal to the image forming unit 1.

The document conveyance unit 3 may not be used. In such a case, the image reading processing can be performed by raising the document conveyance unit 3, directly setting the document sheet D on the platen glass 201 of the image reading unit 2, and moving the scanner unit 202 from left to right for scanning. More specifically, the image reading unit 2 does not need to be provided with the document conveyance unit 3 and may be provide with a document pressing member for pressing a document sheet D set on the platen glass 201.

The image forming unit 1 is a tandem type full color electrophotographic printer having an image forming unit 10 including four image forming stations Y, M, C, and K each of which including a photosensitive drum 11 as an image bearing member. A transfer unit 30 having an intermediate transfer belt 31 is disposed above the image forming unit 10.

The image forming unit 1 forms a toner image on a recording material based on an image signal from a host apparatus such as a personal computer communicably connected with the image reading unit 2 or the image forming unit 1. Recording materials include such sheet materials as paper, plastic films, and cloths. The image forming stations Y, M, and C and K form a yellow, a magenta, a cyan, and a black toner image, respectively. The image forming stations for four different colors have the same configuration except for the developing color. Identical members are assigned the same reference numerals, and the image forming station Y for yellow color will be described below on a representative basis.

The surface of the photosensitive drum 11 as an image bearing member is uniformly charged by a charging roller 12 as a charging device. Then, a latent image is formed on the surface of the photosensitive drum 11 by a laser scanner 13 as an exposure device driven based on a transmitted image information signal. The latent image is visualized as a toner image by a developing device 14.

When the toner image on the photosensitive drum 11 is applied with a predetermined pressure force and an electrostatic load bias by a primary transfer roller 17 as a primary transfer member, the toner image is transferred to the intermediate transfer belt 31 as a belt member. After transfer, a small amount of residual toner on the photosensitive drum 11 is removed and collected by a photosensitive drum cleaner 15. Then, the photosensitive drum 11 becomes ready for the next image forming.

Meanwhile, recording materials P are fed one by one from a cassette 20. A recording material P is conveyed from conveyance roller pairs 22 and 24 to a registration roller pair 23. When the registration roller pair 23 of a registration unit 21 reforms the leading edge of the recording material P to form a loop, skew is corrected. Subsequently, in synchronization with the toner image on the intermediate transfer belt 31, the registration roller pair 23 conveys the recording material P to a secondary transfer portion T2 between the intermediate transfer belt and an outer secondary-transfer roller 35. At the secondary transfer portion T2, an inner secondary-transfer roller 34 is disposed to face the outer secondary-transfer roller 35 across the intermediate transfer belt 31. The intermediate transfer belt 31 and the outer secondary-transfer roller 35 form the secondary transfer portion (NIP portion) T2 for supporting and conveying the recording material P.

At the secondary transfer portion T2, when the color toner image on the intermediate transfer belt 31 is applied with a predetermined pressure force and an electrostatic load bias, the color toner image is transferred to the recording material P. After transfer, a small amount of residual toner on the intermediate transfer belt 31 is removed and collected by a transfer cleaner 36. Then, the intermediate transfer belt 31 becomes ready for the next image forming. The toner image transferred to the recording material P is applied with heat and pressure by a fixing device 40, conveyed through conveyance roller pairs 42 and 43, and then discharged onto a discharge tray 50 by a discharge roller pair 41.

The fixing device 40 includes, for example, a fixing roller 40a including a heat source such as a halogen heater, and a pressure roller 40b for forming a fixing NIP portion with the fixing roller 40a. When the recording material P is conveyed to the fixing NIP portion, the fixing device 40 applies pressure and heat to the toner image on the recording material P to fix the toner image to the recording material P.

### [Transfer Unit]

As described above, the transfer unit 30 as a belt conveyance apparatus includes the intermediate transfer belt 31, the primary transfer roller 17, and the outer secondary-transfer roller 35. The intermediate transfer belt 31, a rotary endless belt member, is stretched by a plurality of tension rollers. According to the present exemplary embodiment, a plurality of tension rollers includes the inner secondary-transfer roller 34 which also serves as a drive roller for rotatably driving the intermediate transfer belt 31, a pre-secondary-transfer roller 38 as a driven roller, a steering roller (stretching roller) 32, and a tension roller 39 on the downstream side of the steering roller 32. The pre-secondary-transfer roller 38 is disposed on the upstream side of the secondary transfer portion T2 in the rotational direction of the intermediate transfer belt 31.

On the other hand, the steering roller 32 as at least one of a plurality of tension rollers is disposed to face the transfer cleaner 36 across the intermediate transfer belt 31. The steering roller 32 is urged by a tension application part such as a spring (not illustrated). The steering roller 32 is configured to apply a tension to the intermediate transfer belt 31 in a state where the outer circumferential surface of the steering roller 32 is in pressure contact with the inner circumferential surface of the intermediate transfer belt 31.

The transfer unit 30 is configured in such a way that the intermediate transfer belt 31 is brought into and out of contact with some of the photosensitive drums 11 by a contact/separation mechanism (not illustrated). More specifically, in the full color mode for forming toner images on all of the image forming stations, the intermediate transfer belt 31 is brought into contact with all of the photosensitive drums 11. With this configuration, the toner images of all colors can be sequentially transferred to the intermediate transfer belt in a superimposed way. On the other hand, in the monochrome mode for forming a black color image, the photosensitive drums 11 of the color image forming stations Y, M, and C are brought out of contact with the intermediate transfer belt 31, and only the photosensitive drum 11 of the black image forming station K is brought into contact with the intermediate transfer belt 31. In this way, only the black toner image can be transferred to the intermediate transfer belt 31.

In the monochrome mode, when the primary transfer rollers 17 corresponding to the color image forming stations Y, M, and C and the tension roller 39 on the downstream side of the steering roller 32 are moved, the intermediate transfer belt 31 is brought out of contact with some of the photosensitive drums 11.

### [Steering Roller]

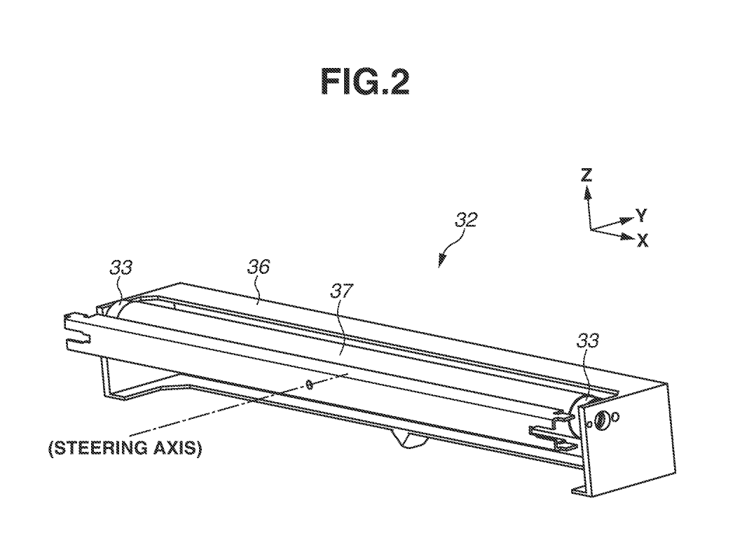

The steering roller 32 will be described below with reference to FIG. 2. The steering roller 32 is tiltably disposed around a steering axis, and includes a roller portion 37 and a sliding ring 33 unrotatably disposed at both axial ends of the roller portion 37. The sliding ring 33 is a sliding portion around which the intermediate transfer belt 31 winds and slidably rotates. The steering roller 32 configured in this way is tilted by the change in the width (sliding width) over which the intermediate transfer belt 31 slides on the sliding ring 33 (described in detail below). This tilting moves the intermediate transfer belt 31 in the width direction intersecting with the rotational direction.

The steering roller 32 is supported by the transfer cleaner 36 to be rotatable around the steering axis disposed at the axial center of the roller portion 37. The steering axis is disposed to perpendicularly intersect with the central axis of the steering roller 32 so that the steering roller 32 tilts in a direction intersecting with the direction in which the steering roller 32 urges the intermediate transfer belt 31. When the steering roller 32 tilts around the steering axis, the track of the intermediate transfer belt 31 changes and the intermediate transfer belt 31 moves in the width direction (automatic belt steering).

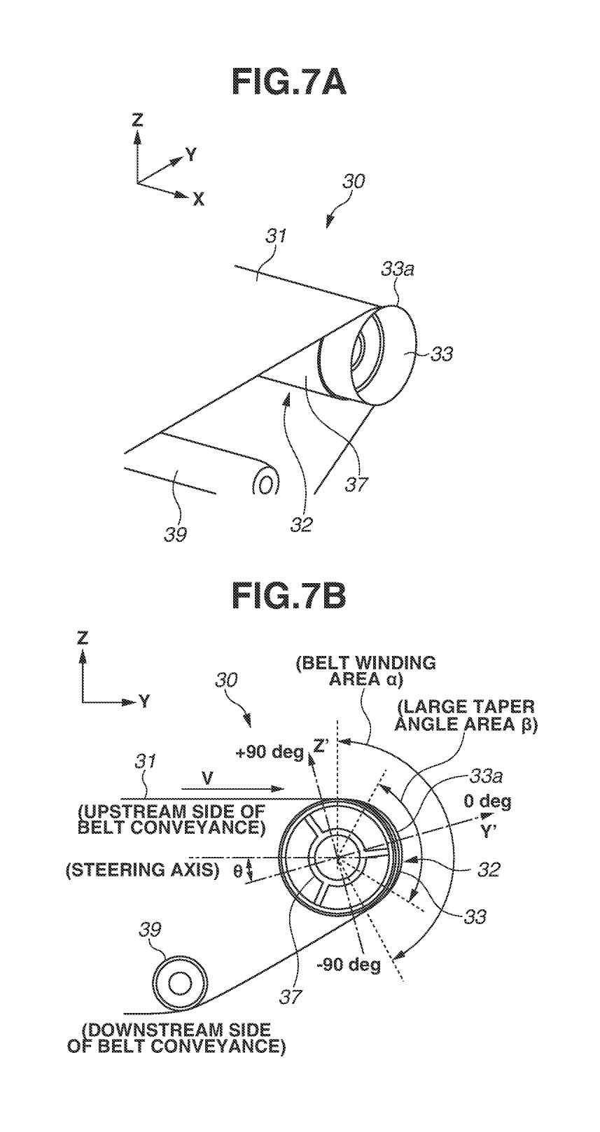

The roller portion 37 is rotatably supported, and driven to rotate by the rotational drive of the intermediate transfer belt 31. The roller portion 37 is provided with the sliding rings 33 at both axial ends. The sliding ring 33 is integrally formed with the transfer cleaner 36 to be undrivable by the rotation of the intermediate transfer belt 31. As illustrated in FIGS. 7A and 7B (described below), the sliding ring 33 has a tapered (inclined) portion 33a where the outer diameter increases toward the axial end side of the steering roller 32 (the end side opposite to the side of the roller portion 37).

### <Principle of Automatic Belt Steering>

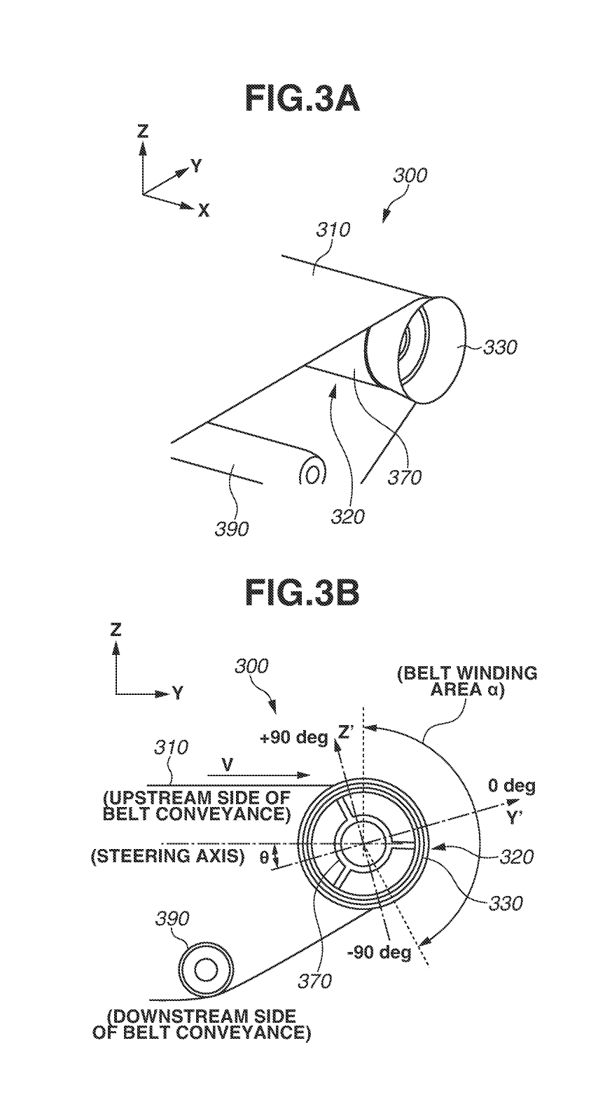

The principle of automatic belt steering according to a comparative example will be described below with reference to FIGS. 3 to 5. As illustrated in FIGS. 3A and 3B, a transfer unit 300 according to the comparative example includes an intermediate transfer belt 310, a steering roller 320, and a tension roller 390. The steering roller 320 includes a roller portion 370 and a sliding ring 330 unrotatably disposed at both axial ends of the roller portion 370. The intermediate transfer belt 31 winds and slidably rotates around the sliding ring 330. The configuration of the transfer unit 300, except for the sliding rings 330, is similar to the configuration of the transfer unit 30 according to the above-described exemplary embodiment.

The outer circumferential surface of the sliding ring 330 according to the comparative example is formed in a tapered shape so that the outer diameter of the tapered portion increases toward the end side over the entire circumference. More specifically, the sliding ring 330 is formed in the shape of an approximately partial cone. The taper angle of the sliding ring 330 remains the same over the entire circumference. The taper angle refers to the inclination angle of the outer circumferential surface with respect to the central axis of the sliding ring 330.

The outer circumferential surface of the sliding ring 330 has a friction coefficient μₛ of about 0.2 and a taper angle of 10 degrees. A resin material such as polyacetal resin (brevity code: POM) having sliding capability is used as the material of the sliding ring 330. The material is also given conductivity in consideration of electrostatic troubles by frictional charge between the intermediate transfer belt 310 and the sliding ring 330. Aluminum is used as the material of the roller portion 370 having a roller diameter of 21 mm and a friction coefficient μᵣ of about 0.3.

Similar to the above-described exemplary embodiment, the intermediate transfer belt 310 is a resin belt including a polyetheretherketone (brevity code: PEEK) base layer having a Young's modulus of about 2400 MPa.

As illustrated in FIG. 3B, it is assumed that the steering axis and the Y-axis of the steering roller 320 are held in parallel, and the Y′ axis is set at the half position of the belt winding area α at which the Y′ axis is assumed to be rotated by 0 degrees from the steering axis around the rotating axis of the steering roller 320.

The sliding ring 330, formed in a tapered shape and disposed at both axial ends of the steering roller 320, is supported to be undrivable during rotation of the intermediate transfer belt 310. Accordingly, when the intermediate transfer belt 310 slides on the sliding ring 330, the sliding ring 330 is subjected to a frictional resistance from the inner circumferential surface of the intermediate transfer belt 310.

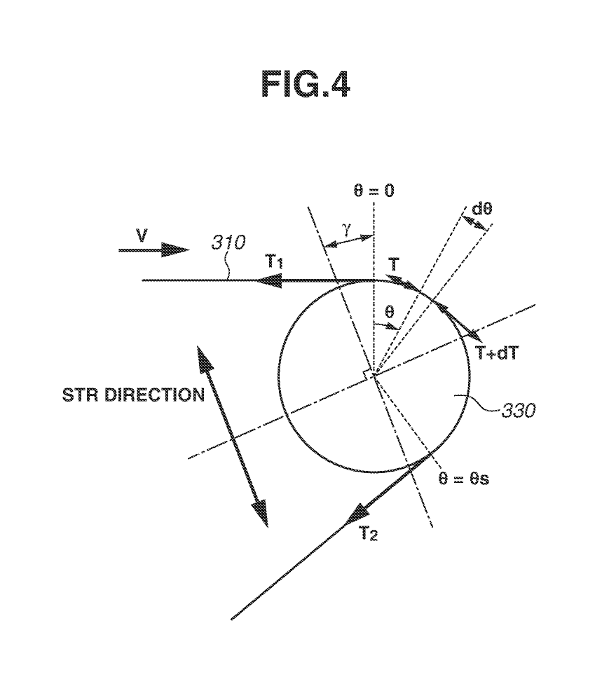

FIG. 4 is a schematic view illustrating a state where the intermediate transfer belt 310 rotating in the direction of the arrow V winds around the sliding ring 330 with a winding angle θs in an automatic belt steering mechanism according to the comparative example. In the automatic belt steering mechanism, when there arises a difference between the sliding width (width of the sliding portion) of the intermediate transfer belt 310 on the sliding ring 330 at one end and the sliding width of the intermediate transfer belt 310 on the sliding ring 330 at the other end, the steering roller 320 tilts toward the relatively larger sliding width (frictional force).

Assuming that a belt circumferential length dx (unit width) is equivalent to a minute winding angle dθ of a certain winding angle θ. The upstream side of the belt circumferential length dx in the rotational direction of the intermediate transfer belt 310 is a slack side, and the downstream side thereof is a tension side. A tension T acts in the tangential direction on the upstream side, and a tension T+dT acts in the tangential direction on the downstream side. Accordingly, if the force of the intermediate transfer belt 310 pressing the sliding ring 330 is approximated to T·dθ in the minute belt length, and the sliding ring 330 has a friction coefficient μₛ, a frictional force df is represented by the formula (1).

df=μₛ·T·dθ (1)

The tension T is governed by the roller portion 370. If the roller portion 370 has a friction coefficient μᵣ, dT is represented by the formula (2).

dT=−μᵣ·T·dθ (2)

Accordingly, dT/T is represented by the formula (2′) from the formula (2).

$$\frac{dT}{T} = - {μ}_{r} d θ \qquad ( {2}^{′} )$$

When the formula (2′) is integrated over the winding angle θs, the tension T is represented by the formula (3), where T1 is the tension at θ=0.

T=T1·e^{(-μ}^{ᵣ}^{·θ)} (3)

Based on the formulas (1) and (3), the frictional force df exerted on the sliding ring 330 is represented by the formula (4).

df=μₛT1·e^{(-μ}^{ᵣ}^{·θ)}dθ (4)

As illustrated in FIG. 4, when the swinging direction of the sliding ring 330 (more specifically, the direction in which the steering roller 320 tilts) is the STR direction indicated by the arrow, the belt winding start position (θ=0) has a deviation angle γ in the swinging direction. Accordingly, the frictional force df represented by the formula (4) downwardly exerted in the STR direction is represented by the formula (5).

$$\begin{matrix}{df}_{STR} = df sin ( θ + γ ) \\ = {μ}_{s} \cdot T 1 \cdot {e}^{( - {μ}_{r} \cdot θ )} sin ( θ + γ ) d θ\end{matrix} \qquad ( 5 )$$

When the component represented by the formula (5) is integrated from θ=0 to θs, the result is a frictional force fᵢ exerted on the sliding ring 330 in the STR direction from the intermediate transfer belt 310 in a unit winding width. Accordingly, a frictional force fᵢ downwardly exerted on the sliding ring 330 in the STR direction from the intermediate transfer belt 310 during rotation of the intermediate transfer belt 310 is represented by the formula (6).

$${f}_{i} = {μ}_{s} \cdot T 1 \cdot {\int }_{0}^{{θ}_{S}} {e}^{( - {μ}_{r} \cdot θ )} sin ( θ + γ ) d θ \qquad ( 6 )$$

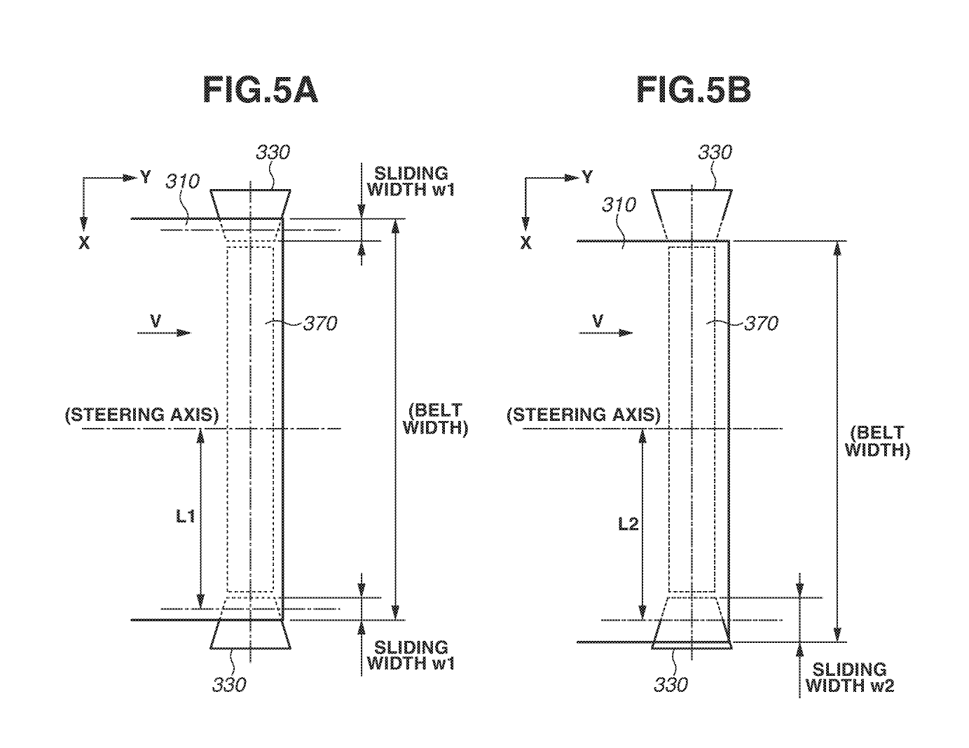

FIG. 5A is a top view schematically illustrating the intermediate transfer belt 310 winding around the sliding rings 330 in the neutral belt lateral position according to the comparative example. Referring to FIG. 5A, the intermediate transfer belt 310 rotates in the direction of the arrow V, no belt lateral movement occurs, and the intermediate transfer belt 310 is conveyed at the center of the steering roller 320. In this state, forces acting on the sliding rings 330 at both axial ends balance. More specifically, a sliding width w1 of the intermediate transfer belt 310 on the sliding ring 330 is the same at both axial ends. More specifically, a frictional force fᵢ·w1 (FIG. 4) exerted on the sliding ring 330 in the STR direction from the intermediate transfer belt 310 is the same at both axial ends. In this state, forces acting on the sliding rings 330 at both axial ends balance.

FIG. 5B is a top view schematically illustrating the intermediate transfer belt 310 winding around the sliding rings 330 in a state where a lateral movement occurs at a belt lateral position according to the comparative example. Referring to FIG. 5B, the intermediate transfer belt 310 rotates in the direction of the arrow V, a belt lateral movement occurs, and the intermediate transfer belt 310 is conveyed while being laterally moved to one side of the steering roller 320. In this state, forces acting on the sliding rings 330 at both axial ends do not balance. For example, assume a sliding width w2 of the intermediate transfer belt 310 on the sliding ring 330 on the side in the direction of the belt lateral movement, and a sliding width 0 on the other side. In this state, the sliding ring 330 on the side in the direction of the belt lateral movement is downwardly applied with a frictional force fᵢ·w2, and the sliding ring 330 on the other side is downwardly applied with a frictional force 0 in the STR direction (illustrated in FIGS. 5A and 5B). Such a difference in the frictional force between both ends of the steering roller 320 produces a moment force (steering torque) fᵢ·w2·L2 around the steering axis. As a result, the steering roller 320 on the side in the direction of the belt lateral movement downwardly tilts to move in the STR direction (FIG. 4).

The tilting direction of the steering roller 320 produced by the above-described principle coincides with the direction in which the lateral movement of the intermediate transfer belt 310 is restored (aligning direction), making it possible to perform automatic steering.

As described above, the sliding ring 330 according to the comparative example is formed in a tapered shape with which the diameter continuously increases toward the outside in the roller axis direction (rotational axis direction of the roller portion 370). When the outer diameter of the roller portion 370 is compared with the outer diameter of the sliding ring 330, the outer diameter of the portion of the sliding ring 330 adjoining the roller portion 370 is equal to the outer diameter of the roller portion 370. The outer diameter of the sliding ring 330 gradually increases to become larger than the outer diameter of the roller portion 370 toward the outside. More specifically, the sliding ring 330 has an inclined portion where the distance between the sliding portion with the intermediate transfer belt 310 and the rotational axis increases as the area in contact with the intermediate transfer belt 310 outwardly shifts in the roller axis direction.

The width of the intermediate transfer belt 310 is larger than the width of the roller portion 370, and is smaller than the width of the steering roller 320 (the roller portion 370 and the sliding rings 330 at both axial ends). More specifically, in a state where the steering roller 320 does not incline in the STR direction, as illustrated in FIG. 5A, the relation between the sliding width of the intermediate transfer belt 310 on the sliding ring 330 is such that the sliding width w1 is identical at both axial ends. The sliding width refers to the width over which both edge portions of the intermediate transfer belt 310 slide on respective sliding rings 330. With the above-described relation between the width of the intermediate transfer belt 310 and the sliding rings 330 at both axial ends, the intermediate transfer belt 310 slides on either one of the sliding rings 330 producing a certain sliding width. With this configuration, the steering operation can be finely performed in response to a belt lateral movement occurrence.

In the configuration of the transfer unit 300, the response of tilting response of the steering roller 320 is determined by adjusting the size of the tapered shape of the sliding ring 330. The taper angle of the sliding ring 330 is provided to adjust the response of the steering tilting and give an excessive amount of the steering torque. If the taper angle is too small, the tilting rudder angle of the steering roller 320 is not given, depending on the configuration. On the other hand, if the taper angle is too large, the low belt rigidity causes waves when the intermediate transfer belt 310 runs on the sliding ring 330. Thus, there is an optimal value of the taper angle of the sliding ring 330 depending on the configuration. If the material of the intermediate transfer belt 310 is a thin resin film, the taper angle of the sliding ring 330 is often set in a range from 8 to 12 degrees.

In this way, a difference in the frictional force balance can be detected in the neutral belt lateral position of the intermediate transfer belt 310. This configuration enables restricting an abrupt steering operation and hence facilitating control of automatic tilting control of the steering roller 320.

In the configuration according to the comparative example, if the material proof strength (yield stress) of the intermediate transfer belt 310 is low, the edge portion of the intermediate transfer belt 310 winding around the sliding ring 330 is likely to be distorted when the intermediate transfer belt 310 runs on the sliding ring 330. This possibly shortens the life of the intermediate transfer belt 31. If the intermediate transfer belt 310 is thin, the intermediate transfer belt 310 is likely to wave, to easily produce a shearing stress at the edge portion of the intermediate transfer belt 310, possibly causing a crack. From the viewpoint of the life of the intermediate transfer belt 310, the configuration according to the comparative example has a problem of susceptibility to the restriction on the material proof strength (yield stress) and thickness of the intermediate transfer belt 310.

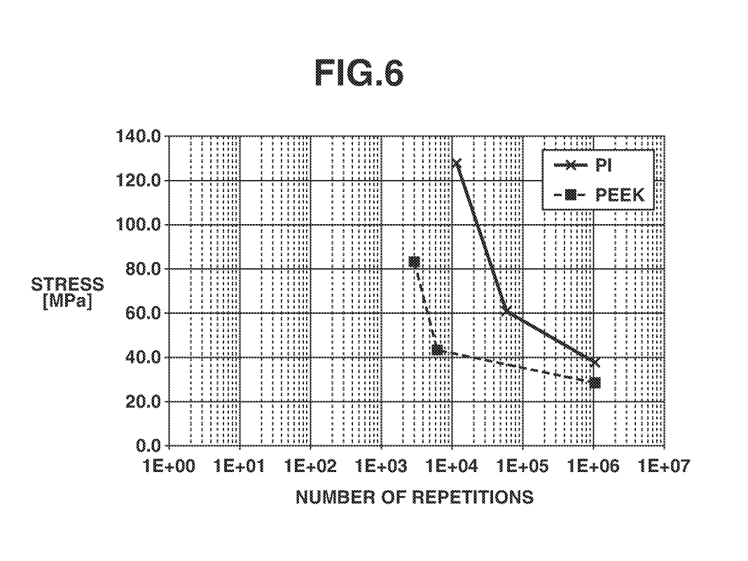

FIG. 6 illustrates fatigue limit curves (S-N curves) of a polyimide thin film and a polyetheretherketone thin film. In accordance with the material proof strength, the yield stress of the polyimide thin film is about 140 MPa and the yield stress of the polyetheretherketone thin film is about 70 MPa. As illustrated in FIG. 6, if the load stress is high, the life of the polyetheretherketone thin film having a lower material proof strength is more likely to be shortened.

When an intermediate transfer belt having a low material proof strength is used in the automatic belt steering configuration, it is desirable to reduce the distortion at the edge portion of the intermediate transfer belt winding around the sliding ring 330 and the deformation stress at the end portion thereof without degrading the steering performance.

### [Detailed Configuration of Transfer Unit According to Present Exemplary Embodiment]

A detailed configuration of the transfer unit 30 according to the present exemplary embodiment will be described below with reference to FIGS. 7A and 7B. The configuration according to the present exemplary embodiment (other than the configuration to be described below) is very similar to the configuration of the above-described comparative example. FIG. 7A is a perspective view illustrating a state where an intermediate transfer belt 31 winds around a sliding ring 33 having a tapered portion 33a according to the present exemplary embodiment. FIG. 7B is a side view illustrating the disposition of a large taper angle area β of the sliding ring 33 having the tapered portion 33a according to the present exemplary embodiment. According to the comparative example, the entire belt winding area α is formed in a tapered shape. According to the present exemplary embodiment, as illustrated in FIG. 7B, the tapered portion 33a of the sliding ring 33 has the large taper angle area β as a part of the belt winding area α.

The tapered portion 33a of the sliding ring 33 has a friction coefficient μₛ of about 0.2. A resin material such as polyacetal resin (brevity code: POM) having sliding capability is used as the material of the sliding ring 33. The material is also given conductivity in consideration of electrostatic troubles by frictional charge between the intermediate transfer belt 31 and the sliding ring 330.

It is desirable that the diameter of a roller portion 37 of a steering roller 32 is 16 to 24 mm. According to the present exemplary embodiment, aluminum is used as the material of the roller portion 37 having a roller diameter of 21 mm and a friction coefficient μᵣ of about 0.3. The roller portion 37 was set to 345.4 mm in length, and the steering roller 32 was set to 364.2 mm in total length (the roller portion 37 and the sliding rings 33 at both axial ends).

The intermediate transfer belt 31 is a resin conveyor belt including a polyetheretherketone (brevity code: PEEK) base layer having a thickness of 0.067 mm, a width of 351 mm, a Young's modulus of 2400 MPa, and a Poisson ratio of 0.4.

The material of the intermediate transfer belt 31 is not limited to polyetheretherketone. The material of the intermediate transfer belt 31 may be other resin materials such as polyimide (brevity code: PI) or metal materials as long as the intermediate transfer belt 31 has a base layer made of a material having an equivalent Young's modulus. Similarly, the materials of the sliding ring 33 and the roller portion 27 may be other materials.

### [About Tapered Portion of Sliding Ring]

The sliding ring 33 as a sliding portion according to the present exemplary embodiment has the tapered (inclined) portion 33a where the outer diameter increases toward the axial end side of the steering roller 32. The tapered portion 33a is formed so that the inclination angle (taper angle) with respect to the central axis of the steering roller 32 differs at least in part in the circumferential direction. Then, the area where the inclination angle is 50% or more of the maximum inclination angle (large taper angle area β) includes the middle position of the belt winding area α for the intermediate transfer belt 31 in the circumferential direction of the tapered portion 33a, and exists over a range occupying 40% or more and 80 % or less of the belt winding area α. The maximum inclination angle of the tapered portion 33a is 5 degrees or more and 15 degrees or less, and the variation in the inclination angle per degree is −1 degree or more and +1 degree or less (±1 degree or less) in the circumferential direction of the belt winding area α. The minimum inclination angle of the tapered portion 33a is less than 50% of the maximum inclination angle. The shape of the sliding ring 33 according to the present exemplary embodiment can be represented by the difference in outer diameter, Δr, between the sliding ring 33 and the steering roller 32 instead of the taper angle. More specifically, in a predetermined cross section of the sliding ring 33 perpendicularly intersecting with the rotating axis of the steering roller 32, the difference in outer diameter between the sliding ring 33 and the steering roller 32 in the belt winding area α is denoted by Δr. The maximum value of the Δr in this cross section is denoted by Δrmax. In this case, the area where the value of the Δr is 50% or more of the Δrmax occupies 40% or more and 80 % or less of the belt winding area α in this cross section. The minimum value of the Δr in this cross section is denoted by Δrmin. In this case, it can be said that the Δrmin is less than 50% of the Δrmax.

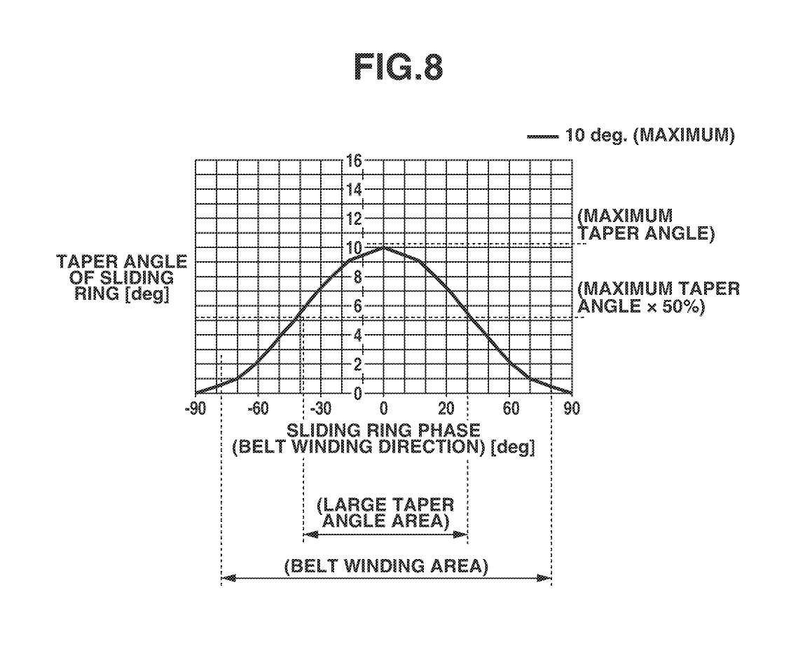

According to the present exemplary embodiment, the taper profile illustrated in FIG. 8 is formed at an arbitrary position of the sliding ring 33. Thus, it is needless to say that the above-described relation of the Δr is satisfied in an arbitrary cross section of the sliding portion perpendicularly intersecting with the rotating axis of the steering roller 32. For example, when the intermediate transfer belt 31 is at the positions illustrated in FIG. 5A and FIG. 5B, the above-described relation is also satisfied in the cross section of a sliding ring 33 at which an edge portion of the intermediate transfer belt 31 is positioned. More specifically, when the sliding width of the intermediate transfer belt 31 on the sliding ring 33 is w1 or w2, the above-described relation is also satisfied in the cross section of the sliding ring 33 at which the edge portion of the intermediate transfer belt 31 is positioned.

### [Reason Why Large Taper Angle Area Occupies 40% or More and 80 % or Less of Winding Area]

The reason why the large taper angle area β occupies 40% or more and 80 % or less of the belt winding area α will be described below. As described above, according to the present exemplary embodiment, the intermediate transfer belt 31 can be brought into and out of contact with some of the photosensitive drums 11 in both the full color mode and the monochrome mode. Accordingly, the belt winding area α of the intermediate transfer belt for the sliding ring 33 of the steering roller 32 differs between the full color mode and the monochrome mode. Thus, the ratio of the large taper angle area β to the belt winding area α also differs between the full color mode and the monochrome mode. More specifically, the monochrome mode provides a larger winding area α than the full color mode. Accordingly, in consideration of such a point, the large taper angle area β occupies 40% or more and 80 % or less of the belt winding area α.

The following describes the basis that the lower limit of the occupying ratio of the large taper angle area β to the belt winding area α was set to 40%. The outer diameter of the roller portion 37 of the steering roller 32 is 21 mm. The sliding ring 33 is shaped to provide a partially elliptical contour having a maximum taper angle of 15 degrees and a taper angle smoothly varying along the circumferential direction of the sliding ring 33.

Under this condition in the full color mode, the large taper angle area β is 78.9 degrees, the belt winding area α is 151.4 degrees, and thus the occupying ratio of the large taper angle area β to the belt winding area α is 52.1%(=78.9 degrees/151.4 degrees×100). In the monochrome mode, on the other hand, the large taper angle area β is 78.9 degrees, the belt winding area α is 177.7 degrees, and thus the occupying ratio of the large taper angle area β to the belt winding area α is 44.4% (78.9 degrees/177.7 degrees×100).

Accordingly, under the above-described conditions, the lower limit of the occupying ratio of the large taper angle area β to the belt winding area α is 44.4% which is the occupancy ratio in the monochrome mode. According to the present exemplary embodiment, the lower limit of the occupying ratio of the large taper angle area β was set to 40% taking a margin into consideration.

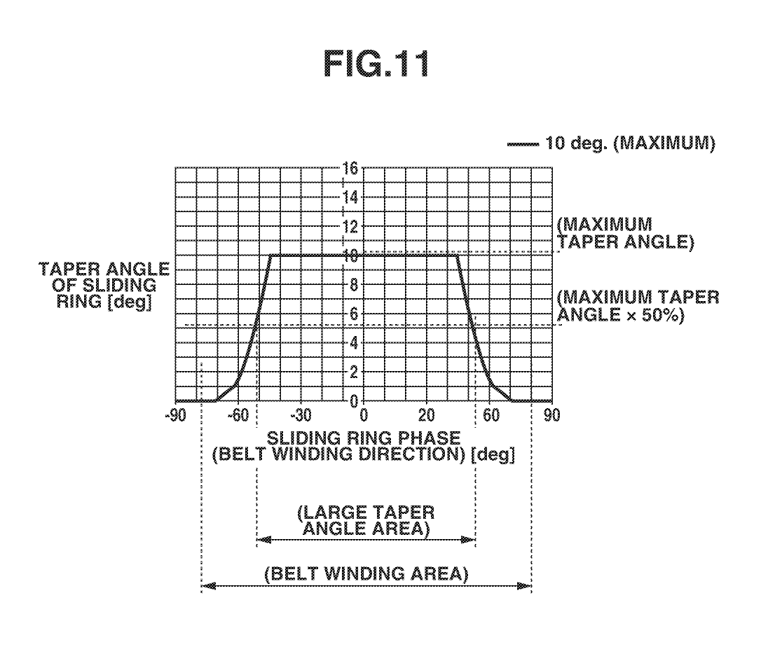

The following describes the basis that the upper limit of the occupying ratio of the large taper angle area β to the belt winding area α was set to 80 %. The outer diameter of the roller portion 37 of the steering roller 32 is 21 mm. The sliding ring 33 is shaped to provide a partially elliptical contour having a maximum taper angle of 10 degrees and a taper angle smoothly varying along the circumferential direction of the sliding ring 33, where the range of the maximum taper angle is circumferentially extended. This shape of the sliding ring 33 is a profile illustrated in FIG. 11 according to a second exemplary embodiment (described below).

Under this condition in the full color mode, the large taper angle area β is 104.9 degrees, the belt winding area α is 151.4 degrees, and thus the occupying ratio of the large taper angle area β to the belt winding area α is 69.3% (104.9 degrees/151.4 degrees×100). Accordingly, under the above-described conditions, the upper limit of the occupying ratio of the large taper angle area β to the belt winding area α is 69.3%. According to the present exemplary embodiment, the upper limit of the occupying ratio of the large taper angle area β was set to 80 %, taking a margin of about 10% into consideration. Even if the maximum taper angle changes, the upper and the lower limits of the occupying ratio of the large taper angle area β remain unchanged.

[Reason Why Maximum Inclination Angle of Tapered Portion 33a Ranges from 5 to 15 Degrees]

As described above, since the taper angle of the sliding ring 33 has an optimal value depending on the configuration of the transfer unit 30, the taper angle is eventually considered and determined according to the actual apparatus.

The steering torque for tilting the steering roller 32 generates a moment force which equals the frictional force between the intermediate transfer belt 31 and the sliding ring 33 multiplied by the arm length (a half of the length of the steering roller 32). However, if the taper angle of the sliding ring 33 is too small, the excessive amount of the steering torque runs short and thus the response of the steering tilting tends to decrease. On the other hand, if the taper angle is too large, the stress at a belt end portion becomes excessive or the belt end portion partially floats from the steering roller 32 because the belt end portion cannot follow the taper shape. In particular, the constricted part of the connecting portion between the steering roller 32 and the sliding ring 33 is likely to float. If the taper angle is too large, the intermediate transfer belt 31 tends to laterally buckle and wave.

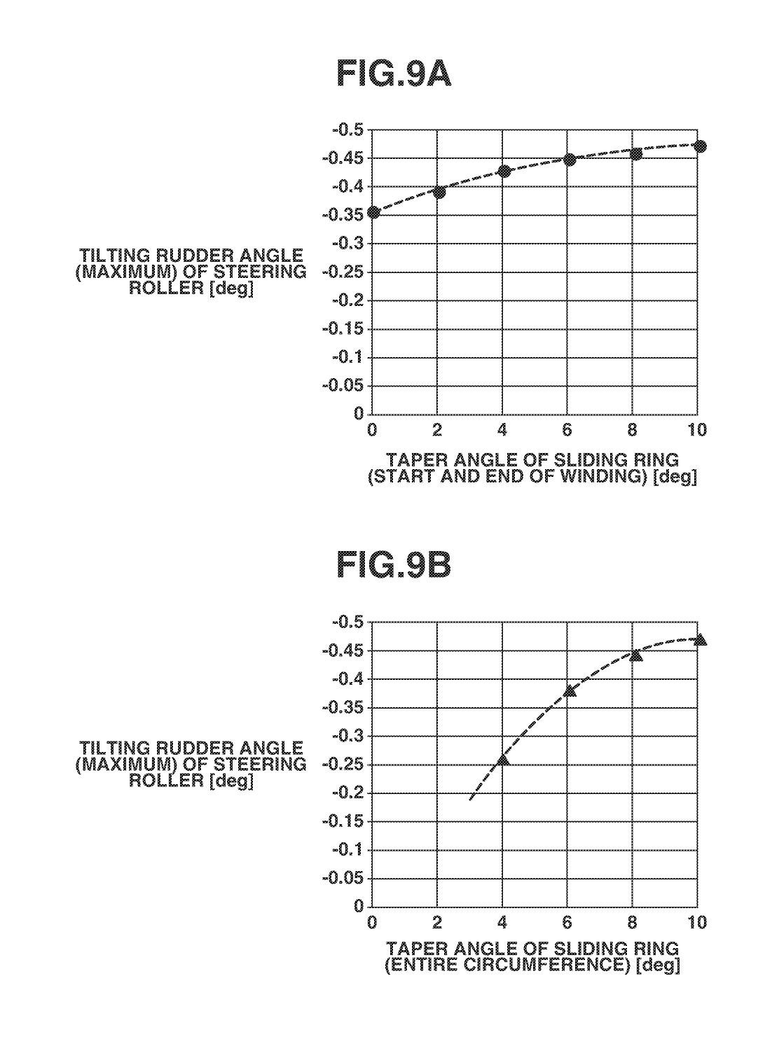

In designing, the steering of the intermediate transfer belt 31 is possible when the rudder angle of the steering roller 32 is 0.3 degrees or larger. As illustrated in FIG. 9B (described below), according to the comparative example in which the sliding ring 33 is tapered over the entire circumference, the steering is possible when the taper angle is about 5 degrees or larger. Thus, according to the present exemplary embodiment, the steering is possible when the maximum inclination angle of the tapered portion 33a of the sliding ring 33 is 5 degrees or larger.

For this reason, according to the present exemplary embodiment, the maximum inclination angle of the tapered portion 33a of the sliding ring 33 is within a range of ±5 degrees from the 10-degree center, i.e., 5 degrees or more and 15 degrees or less. Desirably, the maximum inclination angle is within a range of ±2 degrees from the 10-degree center, i.e., 8 degrees or more and 12 degrees or less.

### [Reason Why Variation of Inclination Angle Per Degree is ±1 Degrees or Less]

The following describes the reason why a variation of the inclination angle (taper angle) per degree in the circumferential direction of the belt winding area α is −1 degree or more and +1 degree or less (±1 degree or less). The outer diameter of the roller portion 37 of the steering roller 32 is 21 mm. The sliding ring 33 is shaped to provide a partially elliptical contour having a maximum taper angle of 10 degrees and a taper angle smoothly varying along the circumferential direction of the sliding ring 33, where the range of the maximum taper angle is circumferentially extended. This shape of the sliding ring 33 is a profile illustrated in FIG. 11 according to the second exemplary embodiment (described below). When the range of the maximum taper angle is extended in this way, a variation of the taper angle increases, and thus a range of the variation of the taper angle is determined with reference to the profile according to the present exemplary embodiment.

Referring to FIG. 11, if the variation of the taper angle is calculated based on the inclination of the taper angle with respect to the phase (circumferential position) of the sliding ring 33, the maximum variation per degree of the phase of the sliding ring 33 is 0.791 degrees. According to the present exemplary embodiment, the variation of the taper angle per degree in the circumferential direction of the belt winding area α is −1 degree or more and +1 degree or less (±1 degree or less) in consideration of a case where the position where the taper angle is maximized is circumferentially deviated.

The taper profile of the sliding ring 33 according to the present exemplary embodiment includes not only a convex shape but also a concave shape. Thus, the variation of the taper angle was set to a range of ±1 degree or less, i.e., −1 degree or more and +1 degree or less, including not only the increased amount but also the decreased amount.

[Reason Why Minimum Inclination Angle of Tapered Portion is Less than 50% of Maximum Inclination Angle]

The following describes why the minimum inclination angle of the tapered portion 33a is less than 50% of the maximum inclination angle. To reduce the stress at the belt end portion, the taper angle at the entrance and the exit (both circumferential end portions) of the belt winding area α is desirably reduced. More specifically, the taper angle at both circumferential end portions of the belt winding area α is desirably as small as possible. Thus, as for the taper angle at both circumferential end portions of the belt winding area α, the lower limit of the minimum taper angle is 0 degrees (more specifically, a straight shape without taper). As described above, the large taper angle area β is an area where the taper angle is 50% or more of the maximum inclination angle. Thus, based on this, the upper limit of the minimum inclination angle of the tapered portion was set to less than 50% of the maximum inclination angle.

As described above, the maximum inclination angle of the tapered portion 33a is 5 degrees or more and 15 degrees or less. When 10 degrees as the center value of the range is set as the maximum inclination angle, 50% of the maximum inclination angle is 5 degrees. Accordingly, in this case, the minimum inclination angle is less than 5 degrees. For example, when the maximum inclination angle of the tapered portion 33a is 15 degrees, less than 50% of the minimum inclination angle is less than 7.5 degrees. Even if the minimum taper angle is less than 7.5 degrees (for example, 7.4 degrees), the stress at the belt end portion can be reduced to a further extent than the case where the taper angle is 15 degrees over the entire winding area α.

According to the present exemplary embodiment, the tapered portion 33a is formed so that, while the above-described conditions are satisfied, the taper angle at the circumferential center of the belt winding area α in the circumferential direction of the tapered portion 33a is larger than the taper angle at both circumferential end portions. The position with the maximum inclination angle of the tapered portion 33a is the middle position (half position) of the belt winding area α in the circumferential direction of the tapered portion 33a. In the belt winding area α, the tapered portion 33a is formed so that the taper angle gradually decreases from the position with the maximum inclination angle to the position with the minimum inclination angle in the circumferential direction.

More specifically, the tapered portion 33a of the sliding ring 33 according to the present exemplary embodiment has a taper profile as illustrated in FIG. 8. More specifically, the tapered portion 33a, having a maximum inclination angle (maximum taper angle) of 10 degrees, provides a taper profile with which the taper angle smoothly varies up to the 10-degree maximum taper angle with respect to the phase in the belt winding direction of the sliding ring 33, thus forming an approximately partially elliptical contour. The position with the maximum taper angle is the 0-degree position on the Y′-axis line illustrated in FIG. 7B, i.e., the half position of the belt winding area α.

As described above, the belt winding area α of the sliding ring 33 differs between the full color mode and the monochrome mode. FIGS. 7A, 7B, and 8 illustrate the belt winding area α in the full color mode.

According to the present exemplary embodiment, the taper profile illustrated in FIG. 8 indicates that the large taper angle area β ranges 85.1 degrees, and the belt winding area α in and the full color mode ranges 151.4 degrees. Accordingly, the ratio (occupying ratio) of the large taper angle area β to the belt winding area α is 56.2%. Referring to the inclination of the taper profile illustrated in FIG. 8, the taper angle varies toward the maximum taper angle by up to 0.174 degrees per degree of the belt winding angle. With the sliding ring 33 according to the present exemplary embodiment, the taper profile of the area more on the side of the belt winding area α than the Z′ axis illustrated in FIG. 7B is as illustrated in FIG. 8. The Z′ axis is an axis perpendicularly intersecting with the central axis of the steering roller 32 and the Y′ axis. On the other hand, the position on the sliding ring 33 at the Z′ axis and the area more on the side opposite to the belt winding area α than the Z′ axis almost does not contact the belt, and may have any shape. According to the present exemplary embodiment, the area on this side is shaped to a cylindrical surface having a taper angle of 0 degrees.

### [Effects of Present Exemplary Embodiment]

According to the present exemplary embodiment, it is possible to ensure the steering performance while reducing the stress at the edge portion of the intermediate transfer belt 31. More specifically, the tapered portion 33a is formed in such a way that the taper angle differs at least in part in the circumferential direction, and that the large taper angle area β where the taper angle is 50% or more of the maximum inclination angle occupies 40% or more and 80 % or less of the belt winding area α of the intermediate transfer belt 31. In addition to this condition, the maximum inclination angle of the tapered portion 33a was set to 5 degrees or more and 15 degrees or less. Sufficient steering performance cannot be ensured if the large taper angle area β occupies less than 40% of the belt winding area α or if the maximum inclination angle is less than 5 degrees. If the large taper angle area β is larger than 80 % of the belt winding area α or if the maximum inclination angle is larger than 15 degrees, the stress at the edge portion of the intermediate transfer belt 31 cannot sufficiently be reduced. Accordingly, forming the tapered portion 33a under the above-described conditions enables ensuring the steering performance while reducing the stress at the edge portion of the intermediate transfer belt 31.

According to the present exemplary embodiment, the variation of the taper angle per degree in the circumferential direction of the belt winding area α is −1 degree or more and +1 degree or less. Accordingly, it is possible to smooth the variation of the taper angle and reduce the stress to the intermediate transfer belt 31 while satisfying the above-described condition for the maximum inclination angle and the condition for the occupying ratio of the large taper angle area β to the belt winding area α.

The position with the maximum inclination angle of the tapered portion 33a is the middle position of the belt winding area α. In the belt winding area α, the tapered portion 33a is formed so that the taper angle gradually decreases from the position with the maximum inclination angle to the position with the minimum inclination angle in the circumferential direction. More specifically, the tapered portion 33a is formed so that the taper angle at the circumferential center of the belt winding area α in the circumferential direction of the tapered portion 33a is larger than the taper angle at both circumferential end portions.

With this configuration, the taper angle of the entrance and exit of the belt winding area α can be reduced to reduce the stress at the edge portion of the belt 31. In the area ranging from the entrance to the center of the belt winding area α, the taper angle gradually increases. In the area ranging from the center to the exit of the belt winding area α, the taper angle gradually decreases. Accordingly, the end portion of the belt are gradually deformed, reducing the stress at the edge portion thereof to a further extent. According to a third exemplary embodiment (described below), setting the position with the maximum inclination angle of the tapered portion 33a to the middle position of the belt winding area α makes it easier to ensure the rudder angle of the steering roller 32. Accordingly, it becomes easy to ensure sufficient steering performance. More specifically, the taper angle of the middle position of the belt winding area α contributes to the steering performance to the most extent.

### EXAMPLES

A simulation performed to confirm the effects of the present exemplary embodiment will be described below. A simulation for calculating the steering performance according to an example satisfying the conditions of the present exemplary embodiment and the steering performance according to the comparative example illustrated in FIGS. 3A and 3B will be described below.

According to the example, 5.6 mm (L2=175.8 mm) was set as the sliding width w2 of the intermediate transfer belt 31 on the sliding ring 33 on the side in the direction of the belt lateral movement during rotation of the intermediate transfer belt 31. The tilting rudder angle of the steering roller 32 in this case was calculated through the simulation. FIG. 9A illustrates the result of the calculation.

In the simulation, the taper angle at the ±90-degree positions of the sliding ring 33B on the Z′ axis line perpendicularly intersecting with the Y′ axis line illustrated in FIG. 7B was varied as illustrated in FIG. 9A (winding starts at +90 degrees and ends at −90 degrees). The tapered portion 33a, having the above-described taper angles and a maximum taper angle fixed to 10 degrees, provides a taper profile with which the taper angle is smoothly varied from the belt winding start and end positions (variable) to the position with the maximum taper angle (fixed), thus forming an approximately partially elliptical contour. The position with the maximum taper angle was set to the 0-degree position on the Y′ axis line illustrated in FIG. 1B. In the simulation, the tilting rudder angle of the steering roller 32 was calculated under this condition.

Accordingly, the 10-degree position on the horizontal axis illustrated in FIG. 9A is equivalent to the case where the taper angle was set to 10 degrees over the entire circumference of the sliding ring 330 in the configuration according to the comparative example illustrated in FIG. 3B. On the other hand, the 0-degree position on the horizontal axis is equivalent to the case in the configuration according to the present exemplary embodiment illustrated in FIGS. 7B and 8.

According to the example, the tapered portion 33a of the sliding ring 33 has the maximum taper shape at a portion contributing to the steering performance (0-degree position on the Y′ axis line illustrated in FIG. 7B). Thus, as illustrated in FIG. 9A, even with a small taper angle at the ±90-degree positions on the Z′ axis line perpendicularly intersecting with the Y′ axis line, the moment (steering torque) around the steering axis of the steering roller 32 can be generated. More specifically, in designing, it is possible to provide a rudder angle of 0.3 degrees or more of the steering roller at which steering is possible. Accordingly, even if the minimum taper angle of the tapered portion 33a of the sliding ring 33 is set to less than 50% of the maximum taper angle, the steering performance can be ensured.

On the other hand, according to the comparative example (FIGS. 3A and 3B), 5.6 mm (L2=175.8 mm) was set as the sliding width w2 of the intermediate transfer belt 310 on the sliding ring 330 on the side in the direction of the belt lateral movement during rotation of the intermediate transfer belt 310. The tilting rudder angle of the steering roller 320 in this case was calculated through the simulation. FIG. 9B illustrates the result of the calculation.

More specifically, the sliding ring 330 according to the comparative example has an equal taper angle over the entire circumference. The taper angle was varied as illustrated in FIG. 9B, and the tilting rudder angle of the steering roller 320 was calculated for each taper angle.

As illustrated in FIG. 9B, when the taper angle is reduced from 10 to 4 degrees, the rudder angle of the steering roller 320 is halved. This is because the taper angle of a portion contributing to the steering performance (0-degree position on the Y′ axis line illustrated in FIG. 3B) also decreases. When the taper angle at a portion contributing to the steering performance decreases, the moment (steering torque) around the steering axis of the steering roller 320 also decreases. As a result, the steering performance for giving a steering roller rudder angle will be largely degraded.

According to the example, on the other hand, it turned out that the sliding ring 33 is provided with the steering performance with a taper angle of 5 degrees or more over the entire circumference according to the comparative example even if the minimum taper angle value of the tapered portion 33a of the sliding ring 33 was set to 0% of the maximum taper angles (0 degree on the horizontal axes illustrated in FIG. 9A).

The following describes a simulation for calculating the stress at the end portions of the intermediate transfer belt winding around the sliding rings according to the example and the comparative example.

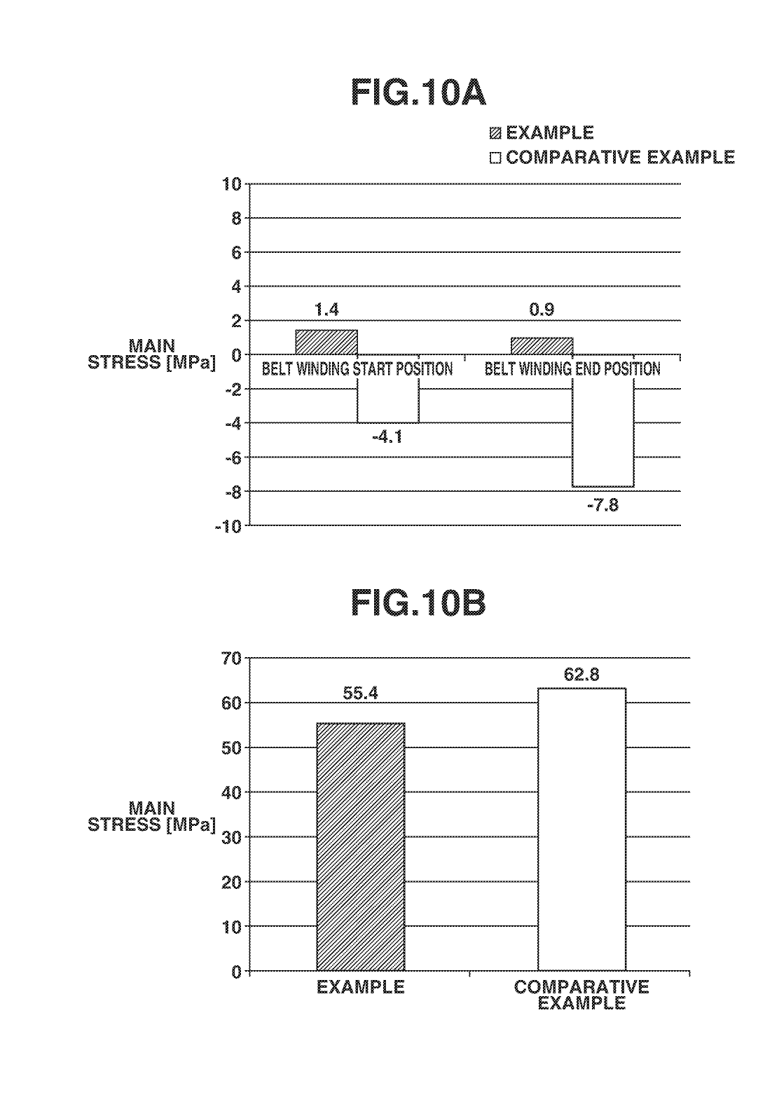

According to the example and the comparative example, 5.6 mm (L2=175.8 mm) was set as the sliding width w2 of the intermediate transfer belt on the sliding ring on the side in the direction of the belt lateral movement during rotation of the intermediate transfer belt. Under this condition, the simulation calculated a principal stress at the end portions of the intermediate transfer belt winding around the sliding ring on the side in the direction of the belt lateral movement according to the example and the comparative example. FIG. 10A illustrates the result of the calculation.

Under the same condition as the condition illustrated in FIG. 10A, the simulation calculated the maximum value of a principal stress at the edge portion of the intermediate transfer belt winding around the sliding ring on the side in the direction of the belt lateral movement according to the example and the comparative example. FIG. 10B illustrates the result of the calculation.

The sliding ring 33 according to the example illustrated in FIGS. 10A and 10B provides a taper profile with which the taper angle smoothly varies from a 2-degree taper angle at the ±90-degree positions on the Z′ axis line perpendicularly intersecting with the Y′ axis line illustrated in FIG. 7B up to the 10-degree maximum taper angle, thus forming an approximately partially elliptical contour. According to the example, the position with the maximum taper angle was set to the 0-degree position on the Y′ axis line illustrated in FIG. 7B, and a principal stress of the intermediate transfer belt 31 was calculated. On the other hand, for the sliding ring 330 according to the comparative example, the taper angle was set to 6 degrees over the entire circumference to achieve the same steering roller rudder angle (steering torque) according to the example, and a principal stress of the intermediate transfer belt 310 was similarly calculated.

As illustrated in FIG. 10A, according to the example, the principal stress at the belt winding start position was +1.4 MPa, the principal stress at the belt winding end position was +0.9 MPa, and the stress amplitude Δ was 0.5 MPa. On the other hand, according to the comparative example, the principal stress at the belt winding start position was −4.1 MPa, the principal stress at the belt winding end position was −7.8 MPa, and the stress amplitude Δ was 3.7 MPa. As illustrated in FIG. 10B, the maximum value of the principal stress at the belt edge portion was +55.4 MPa according to the example, and was +62.8 MPa according to the comparative example.

As described above, it turned out that the example provides smaller principal stress values at the belt winding start and the belt winding end positions than the comparative example. This means that the present exemplary embodiment reduces the distortion at the edge portion of the intermediate transfer belt 31 winding around the sliding ring 33 and the deformation stress at the end portions of the belt. It also turned out that the example provides smaller stress amplitude values than the comparative example. This means that the present exemplary embodiment is also advantageous from the viewpoint of the life of the intermediate transfer belt 31. As described above, it turned out that the present exemplary embodiment makes it possible to reduce the distortion at the edge portion of the intermediate transfer belt 31 winding around the sliding ring 33 and the deformation stress at the end portions of the belt without degrading the steering performance.

A second exemplary embodiment will be described below with reference to FIG. 11, referring to FIGS. 7A and 7B. FIG. 11 illustrates a taper profile of the tapered portion of the sliding ring according to the present exemplary embodiment. With the taper profile according to the present exemplary embodiment, the range of the 10-degree maximum taper angle is extended with respect to the phase in the belt winding direction of the sliding ring 33 according to the first exemplary embodiment. Other configurations and actions according to the present exemplary embodiment are similar to those according to the first exemplary embodiment, and the following descriptions will be made centering on differences from the first exemplary embodiment.

According to the present exemplary embodiment, the sliding ring 33 provides a taper profile with which the range of the 10-degree maximum taper angle of the sliding ring is extended by ±45 degrees (from −45 to +45 degrees) with reference to the Y′ axis (FIG. 7B). Referring to the taper profile of the sliding ring 33 illustrated in FIG. 11, the large taper angle area β according to the present exemplary embodiment ranges 104.9 degrees. Since the belt winding area α in the full color mode ranges 151.4 degrees, the ratio (occupying ratio) of the large taper angle area β to the belt winding area α is 69.3%. Referring to the inclination of the taper profile illustrated in FIG. 11, the taper angle varies toward the maximum taper angle by up to 0.791 degrees per degree of the belt winding angle.

The present exemplary embodiment also satisfies the above-described conditions according to first exemplary embodiment. Thus, similar to the first exemplary embodiment, it is possible to reduce the distortion at the edge portion of the intermediate transfer belt winding around the sliding ring and the deformation stress at the end portions thereof without degrading the steering performance.

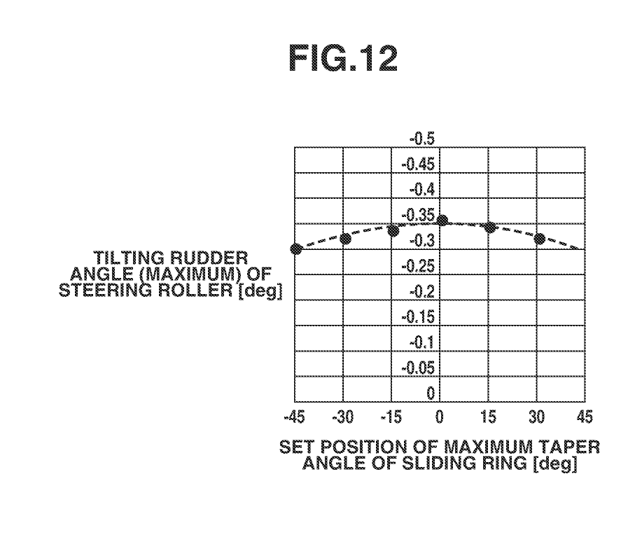

A third exemplary embodiment will be described below with reference to FIG. 12, referring to FIGS. 7A and 7B. According to the present exemplary embodiment, the position with the maximum inclination angle of the tapered portion is included in the range of ±45 degrees (−45 degrees or more and +45 degrees or less) with reference to the middle position of the belt winding area α in the circumferential direction of the tapered portion. More specifically, the following describes a case where the position with the maximum taper angle is not fixed to the middle position of the belt winding area α but included in the range of ±45 degrees around this position. Other configurations and actions according to the exemplary embodiment are similar to those according to the first exemplary embodiment, and the following descriptions will be made centering on differences from the first exemplary embodiment.

In the configuration illustrated in FIGS. 7A and 7B, the simulation calculated the tilting rudder angle of the steering roller 32 when the position with the maximum taper angle is varied in the range of ±45 degrees around the middle position of the belt winding area α. FIG. 12 illustrates the result of the calculation. In this case, 5.6 mm (L2=175.8 mm) was set as the sliding width w2 of the intermediate transfer belt on the sliding ring on the side in the direction of the belt lateral movement during rotation of the intermediate transfer belt.

For the 0-degree position on the horizontal axis illustrated in FIG. 12, the 0-degree position (middle position of the belt winding area α) on the Y′ axis line illustrated in FIG. 7B was set as the position with the maximum taper angle. The sliding ring according to the present exemplary embodiment provides a taper profile with which the taper angle smoothly varies from the 0-degree taper angle at the ±90-degree positions on the Z′ axis line perpendicularly intersecting with the Y′ axis line up to the 10-degree maximum taper angle illustrated in FIGS. 7B and 8, thus forming an elliptical contour.

As illustrated in FIG. 12, it turned out that the tilting rudder angle of the steering roller 32 was maximized at the 0-degree position with the maximum taper angle, and that, when the position with the maximum taper angle was varied with reference to this position (0 degrees), the value gently decreased in both the positive and the negative directions. Thus, it turned out that setting the middle position of the belt winding area α (0-degree position on the Y′ axis line illustrated in FIG. 7B) as the position with the maximum taper angle enables maximizing the moment around the steering axis of the steering roller 32.

It turned out that, in designing, if the rudder angle was set to 0.3 degrees or more of the steering roller at which steering is possible, the position with the maximum taper angle according to the present exemplary embodiment can be set at an arbitrary position in the range of ±45 degrees with reference to the middle position of the belt winding area α.

As described above, also in the present exemplary embodiment, it is possible to reduce the distortion at the edge portion of the intermediate transfer belt winding around the sliding ring and the deformation stress at the end portions thereof without degrading the steering performance.

The above-described exemplary embodiments are on the premise that the steering axis of the steering roller is parallel to the Y axis (FIG. 7B). However, the steering axis can be suitably set according to the configuration. For example, the steering axis may be disposed on the Y′ axis (FIG. 7B) at the middle position of the belt winding area α. A plurality of steering rollers may be provided. In this case, it is desirable that all of the steering rollers satisfy the conditions according to the above-described exemplary embodiments.

Although the above-described exemplary embodiments are on the premise that a belt member is the intermediate transfer belt, the belt member is applicable not only to the intermediate transfer belt but also to a recording material conveyance belt, a fixing belt, a pressure belt, and other belts configured to rotate while being stretched by a plurality of rollers. A recording material conveyance belt electrostatically absorbs and conveys a recording material. In an example configuration using a recording material conveyance belt, toner images are directly transferred from photosensitive drums to a recording material borne by the recording material conveyance belt. A fixing belt as a member of a fixing device is pressurized to heat a toner image borne by a conveyed recording material. A pressure belt is a belt for forming a fixing NIP portion for heating and pressurizing a recording material between the pressure belt and a fixing roller or a fixing belt of a fixing device.

Image forming apparatuses to which the above-described belt conveyance apparatus is applicable include copying machines, printers, facsimiles, and multifunction peripherals having a plurality of functions of these apparatuses.

Although, in the present exemplary embodiment, the tapered portion 33a is linearly formed in a cross section including the rotating axis of the steering roller, the tapered portion 33a may be formed as a curved surface. In this case, the inclination angle is defined by the angle between a tangential plane in contact with the curved surface and the rotating axis of the steering roller.

According to the present disclosure, it is possible to provide a configuration for ensuring steering performance while reducing a stress at edge portions of a belt member.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-014908, filed Jan. 30, 2017, which is hereby incorporated by reference herein in its entirety.

What is claimed is:

1. A belt conveyance apparatus comprising:
an endless belt member configured to rotate; and
a stretching roller configured to stretch the belt member and tilt to make the belt member movable in a lateral direction intersecting with a rotational direction of the belt member, the stretching roller including a roller portion configured to rotate together with the belt member, and a sliding portion, that does not rotate together with the belt member, disposed at both ends of the roller portion with respected to a rotating axis line of the roller portion and configured to allow the belt member to slide,
wherein a distance between an outer surface of the sliding portion at a first position and an outer surface of the roller portion with respect to a radial direction of the roller portion in a first predetermined cross section including the rotating axis line of the roller portion is larger than a distance between an outer surface of the sliding portion at a second position and an outer surface of the roller portion with respect to the radial direction in the first predetermined cross section, the second position is inside the first position with respect to the rotating axis line of the roller portion,
wherein when a distance between an outer surface of the sliding portion and an outer surface of the roller portion with respect to a radial direction of the roller portion in a second predetermined cross section perpendicularly intersecting with the rotating axis line of the roller portion is denoted by Δr, and a maximum value of the Δr in a winding area where the belt member winds is denoted by Δrmax, the Δr at a middle position of the winding area with respect to a rotational direction of the roller portion is 50% or more of the Δrmax, and an area, where the Δr is 50% or more of the Δrmax occupies 40% or more and 80 % or less of the entire winding area, and
wherein the second predetermined cross section passes through a lateral end of the belt member when a lateral center position of the belt member is positioned at a lateral center of the roller portion.

2. The belt conveyance apparatus according to claim 1, wherein the Δr at an area within ±45 degrees with reference to the middle position of the winding area is 50% or more of the Δrmax.

3. The belt conveyance apparatus according to claim 1, wherein the Δr at both end portions of the winding area is less than 0.3 mm.

4. The belt conveyance apparatus according to claim 1, wherein an area where the Δr=the Δrmax exists in an area within ±45 degrees with reference to the middle position of the winding area.

5. The belt conveyance apparatus according to claim 1, wherein a variation of an inclination angle of the sliding portion per degree in a circumferential direction of the winding area is −1 degree or more and +1 degree or less in the second predetermined cross section.

6. A belt conveyance apparatus comprising:
an endless belt member configured to rotate; and
a stretching roller configured to stretch the belt member and tilt to make the belt member movable in a lateral direction intersecting with a rotational direction of the belt member, the stretching roller including a roller portion configured to rotate together with the belt member, and a sliding portion, that does not rotate together with the belt member, disposed at both ends of the roller portion with respected to a rotating axis line of the roller portion and configured to allow the belt member to slide,
wherein a distance between an outer surface of the sliding portion at a first position and an outer surface of the roller portion with respect to a radial direction of the roller portion in a first predetermined cross section including the rotating axis line of the roller portion is larger than a distance between an outer surface of the sliding portion at a second position and an outer surface of the roller portion with respect to the radial direction in the first predetermined cross section, the second position is inside the first position with respect to the rotating axis line of the roller portion,
wherein when a distance between an outer surface of the sliding portion and an outer surface of the roller portion with respect to a radial direction of the roller portion in a second predetermined cross section perpendicularly intersecting with the rotating axis line of the roller portion is denoted by Δr, and a maximum value of the Δr in a winding area where the belt member winds is denoted by Δrmax, the Δr at a middle position of the winding area with respect to a rotational direction of the roller portion is 50% or more of the Δrmax, and an area, where the Δr is 50% or more of the Δrmax occupies 40% or more and 80 % or less of the entire winding area, and
wherein the second predetermined cross section passes through a position where, when one lateral end of the belt member is positioned at one lateral end of the roller portion, the other lateral end of the belt member is positioned.

7. The belt conveyance apparatus according to claim 6, wherein the Δr at an area within ±45 degrees with reference to the middle position of the winding area is 50% or more of the Δrmax.

8. The belt conveyance apparatus according to claim 6, wherein the Δr at both end portions of the winding area is less than 0.3 mm.

9. The belt conveyance apparatus according to claim 6, wherein an area where the Δr=the Δrmax exists in an area within ±45 degrees with reference to the middle position of the winding area.

10. The belt conveyance apparatus according to claim 6, wherein a variation of an inclination angle of the sliding portion per degree in a circumferential direction of the winding area is −1 degree or more and +1 degree or less in the second predetermined cross section.

11. A belt conveyance apparatus comprising:
an endless belt member configured to rotate; and
a stretching roller configured to stretch the belt member and tilt to make the belt member movable in a lateral direction intersecting with a rotational direction of the belt member, the stretching roller including a roller portion configured to rotate together with the belt member, and a sliding portion, that does not rotate together with the belt member, disposed at both ends of the roller portion with respected to a rotating axis line of the roller portion and configured to allow the belt member to slide,
wherein a distance between an outer surface of the sliding portion at a first position and an outer surface of the roller portion with respect to a radial direction of the roller portion in a first predetermined cross section including the rotating axis line of the roller portion is larger than a distance between an outer surface of the sliding portion at a second position and an outer surface of the roller portion with respect to the radial direction in the first predetermined cross section, the second position is inside the first position with respect to the rotating axis line of the roller portion,
wherein when a distance between an outer surface of the sliding portion and an outer surface of the roller portion with respect to a radial direction of the roller portion in a second predetermined cross section perpendicularly intersecting with the rotating axis line of the roller portion is denoted by Δr, a maximum value of the Δr in a winding area where the belt member winds is denoted by Δrmax, and a minimum value of the Δr in the winding area is denoted by Δrmin, the Δrmin is less than 50% of the Δrmax, the Δr at a middle position of the winding area with respect to a rotational direction of the roller portion is 50% or more of the Δrmax, and the Δr at both end portions of the winding area of the belt member is less than 50% of the Δrmax, and
wherein the second predetermined cross section passes through a position where a lateral end of the belt member is positioned when a lateral center position of the belt member is positioned at a lateral center of the roller portion

12. The belt conveyance apparatus according to claim 11, wherein the Δr at an area within ±45 degrees with reference to the middle position of the winding area is 50% or more of the Δrmax.

13. The belt conveyance apparatus according to claim 11, wherein the Δr at both end portions of the winding area is less than 0.3 mm.

14. The belt conveyance apparatus according to claim 11, wherein an area where the Δr=the Δrmax exists in an area within ±45 degrees with reference to the middle position of the winding area.

15. The belt conveyance apparatus according to claim 11, wherein a variation of an inclination angle of the sliding portion per degree in a circumferential direction of the winding area is −1 degree or more and +1 degree or less in the second predetermined cross section.

16. A belt conveyance apparatus comprising:
an endless belt member configured to rotate; and
a stretching roller configured to stretch the belt member and tilt to make the belt member movable in a lateral direction intersecting with a rotational direction of the belt member, the stretching roller including a roller portion configured to rotate together with the belt member, and a sliding portion, that does not rotate together with the belt member, disposed at both ends of the roller portion with respected to a rotating axis line of the roller portion and configured to allow the belt member to slide,
wherein a distance between an outer surface of the sliding portion at a first position and an outer surface of the roller portion with respect to a radial direction of the roller portion in a first predetermined cross section including the rotating axis line of the roller portion is larger than a distance between an outer surface of the sliding portion at a second position and an outer surface of the roller portion with respect to the radial direction in the first predetermined cross section, the second position is inside the first position with respect to the rotating axis line of the roller portion,
wherein, in the sliding portion, when a distance between an outer surface of the sliding portion and an outer surface of the roller portion with respect to a radial direction of the roller portion in a second predetermined cross section perpendicularly intersecting with the rotating axis line of the roller portion is denoted by Δr, a maximum value of the Δr in a winding area where the belt member winds is denoted by Δrmax, and a minimum value of the Δr in the winding area is denoted by Δrmin, the Δrmin is less than 50% of the Δrmax, the Δr at a middle position of the winding area with respect to a rotational direction of the roller portion is 50% or more of the Δrmax, and the Δr at both end portions of the winding area is less than 50% of the Δrmax, and
wherein the second predetermined cross section is perpendicularly intersecting with the rotating axis line of the roller portion, and passing through a lateral end of the belt member when a lateral center position of the belt member is positioned at a lateral center of the roller portion.

17. The belt conveyance apparatus according to claim 16, wherein the Δr at an area within ±45 degrees with reference to the middle position of the winding area is 50% or more of the Δrmax.

18. The belt conveyance apparatus according to claim 16, wherein the Δr at both end portions of the winding area is less than 0.3 mm.

19. The belt conveyance apparatus according to claim 16, wherein an area where the Δr=the Δrmax exists in an area within ±45 degrees with reference to the middle position of the winding area.

20. The belt conveyance apparatus according to claim 16, wherein a variation of an inclination angle of the sliding portion per degree in a circumferential direction of the winding area is −1 degree or more and +1 degree or less in the second predetermined cross section.
